(19) United States
(12) Patent Application Publication
(10) Pub. No.: US 2018/0322689 A1
(43) Pub. Date: Nov. 8, 2018

(54) VISUALIZATION AND RENDERING OF IMAGES TO ENHANCE DEPTH PERCEPTION

(71) Applicant: UNIVERSITY OF MARYLAND, COLLEGE PARK, College Park, MD (US)

(72) Inventors: Sujal BISTA, Rockville, MD (US); Amitabh VARSHNEY, Potomac, MD (US)

(21) Appl. No.: 15/972,809

(22) Filed: May 7, 2018

Related U.S. Application Data
(60) Provisional application No. 62/502,296, filed on May 5, 2017.

(51) Int. Cl. G06T 15/20; G06T 7/579; G06T 17/20; G06T 7/20

(52) U.S. Cl. CPC G06T 15/205; G06T 7/20; G06T 17/20; G06T 7/579

(57) ABSTRACT

Various communication systems may benefit from improved depth perception of images. For example, it may be helpful to enhance depth perception of a three-dimensional rendering of an image. A method, according to certain embodiments, may include acquiring at an apparatus a pair of images. The method may also include computing an energy map based on one or more kinetic parameters of the pair of images. In addition, the method may include generating a kinetic depth image based on the energy map.

### CROSS-REFERENCE TO RELATED APPLICATION

This application is related to and claims the benefit and priority of U.S. Provisional Patent Application No. 62/502,296 filed May 5, 2017, the entirety of which is hereby incorporated herein by reference.

### GOVERNMENT LICENSE RIGHTS

This invention was made with government support under CNS1429404 awarded by NSF. The government has certain rights in the invention.

### BACKGROUND

### Field

Various communication systems may benefit from improved depth perception of images. For example, it may be helpful to enhance depth perception of a three-dimensional rendering of an image.

### Description of the Related Art

Various technologies exist that are capable of transforming still images of an object into an image that appears to an observer to be a three-dimensional rendering of the object. One such technology is kinetic depth effect (KDE). KDE is defined as a perception of a three-dimensional structural form of an object when viewing the object in motion. An image that uses the KDE is referred to as a Kinetic Depth Image (KDI). Images that exhibit KDE are sometimes referred to as Wiggle Images, Piku-Piku, flip images, animated stereo, and GIF 3D. As an observer of the KDI moves, nearby objects are seen from different angles. With the increasing availability of stereo and lightfield cameras, the use of the KDE to express depth on ordinary displays is rising rapidly.

Stereo kinetic effect (SKE) is another technology used to transform still images. SKE gives a perception of depth when viewing a two dimensional (2D) pattern as it is rotated in a view plane, such as a fronto-parallel plane. On the other hand, the depth perception in the KDE arises from rotating the object along an axis, rather than a fronto-parallel plane. KDE is associated with the rotational viewing of objects, whereas motion parallax is associated with translational viewing of objects.

Although there are many KDE-based images, most of the KDE-based images are manually created by artists, require tedious user input, and/or suffer from visual artifacts introduced by the automated systems used to create them. While manual creation of these images is possible, it is not possible for average users to make their own high-quality KDE-based images. Traditional KDI creation also suffers from deficiencies caused by abrupt changes in motion, color, or intensity, as well as alignment errors and excessive motion.

### SUMMARY

According to certain embodiments, an apparatus may include at least one memory including computer program code, and at least one processor. The at least one memory and the computer program code may be configured, with the at least one processor, to cause the apparatus at least to acquire a pair of images. The at least one memory and the computer program code may also be configured, with the at least one processor, to cause the apparatus at least to compute an energy map based on one or more kinetic parameters of the pair of images. In addition, the at least one memory and the computer program code may be configured, with the at least one processor, to cause the apparatus at least to generate a kinetic depth image based on the energy map.

A method, according to certain embodiments, may include acquiring at an apparatus a pair of images. The method may also include computing an energy map based on one or more kinetic parameters of the pair of images. In addition, the method may include generating a kinetic depth image based on the energy map.

An apparatus, in certain embodiments, may include means for acquiring a pair of images. The apparatus may also include means for computing an energy map based on one or more kinetic parameters of the pair of images. In addition, the apparatus may include means for generating a kinetic depth image based on the energy map.

According to certain embodiments, a non-transitory computer-readable medium encoding instructions that, when executed in hardware, perform a process. The process may include acquiring at an apparatus a pair of images. The process may also include computing an energy map based on one or more kinetic parameters of the pair of images. In addition, the process may include generating a kinetic depth image based on the energy map.

According to certain other embodiments, a computer program product may encode instructions for performing a process. The process may include acquiring at an apparatus a pair of images. The process may also include computing an energy map based on one or more kinetic parameters of the pair of images. In addition, the process may include generating a kinetic depth image based on the energy map.

An apparatus, in certain embodiments, may include circuitry for acquiring a pair of images. The apparatus may also include circuitry for computing an energy map based on one or more kinetic parameters of the pair of images. In addition, the apparatus may include circuitry for generating a kinetic depth image based on the energy map.

### BRIEF DESCRIPTION OF THE DRAWINGS

For proper understanding of the invention, reference should be made to the accompanying drawings, wherein:

FIG. 1 illustrates an example of a flow diagram according to certain embodiments.

FIG. 2 illustrates an example of a diagram according to certain embodiments.

FIG. 3 illustrates an example of a diagram according to certain embodiments.

FIG. 4 illustrates an example of diagrams according to certain embodiments.

FIG. 5 illustrates an example of a flow diagram according to certain embodiments.

FIG. 6 illustrates an example of a system according to certain embodiments.

### DETAILED DESCRIPTION

The use of KDE may be a viable alternative to using stereoscopic and autostereoscopic displays. KDE, for example, provides monocular depth cues so that an observer may perceive depth, even using only one eye, which accommodates people who suffer from various monocular disorders. KDE also provides for depth perception due to the rotation of the object, and may not require any special devices for viewing, such as glasses or lenses. Unlike stereoscopic and auto-stereoscopic displays, KDE animations do not suffer from vergence-accommodation conflict. Rather, depth perception achieved by the KDE may exceed binocular depth perception as the disparity provided by binocular vision is limited compared to the angular rotation that can be produced by KDE.

Certain embodiments, therefore, may allow for the automatic generation of a KDI based on a pair of images. The pair of images may be part of a collection of images. In generating the KDI, some embodiment may account for depth perception, image saliency, identification of the best rotation axis, identification of good pivot points for fixation, and/or depth re-mapping to generate high quality KDE. Some embodiment may also allow for the decoupling of the rendering camera from the acquisition camera. The acquisition camera, also referred to as the input camera, may be the camera used to take the initial images, while the camera used for generating the KDI may be the rendering camera. Decoupling the rendering and acquisition cameras may allow for greater freedom in using the standard angular camera with substantially fewer visual artifacts, as well as previously unexplored camera motions to achieve the KDE. In other embodiments, however, the acquisition and rendering may be performed by the same camera.

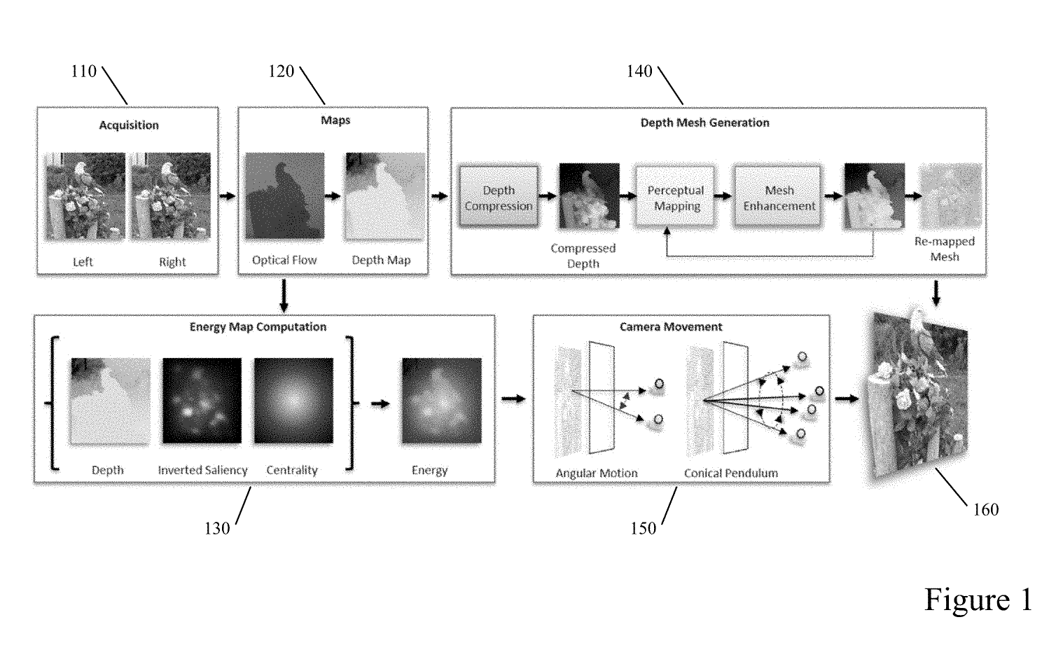

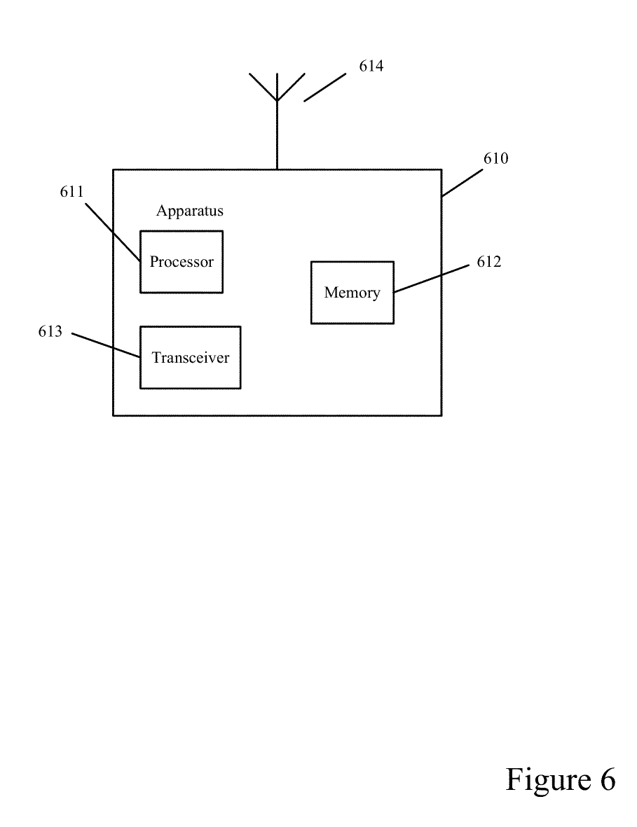

FIG. 1 illustrates an example of a flow diagram according to certain embodiments. In particular, FIG. 1 illustrates a process or method by which to achieve a resulting KDI. As can be seen in step 110, a pair of images may be acquired or inputted. The images, for example, may be static images or video images that are acquired via an input or acquisition camera, and/or vector graphics or other three dimensional gestural drawings, which may be drawn, for example, by a user's hands in the air and may be tracked by a camera or some other tracking device. In some other embodiment, the images may include a light field, which may be an image acquired from multiple cameras. In other embodiments, any other type of image or graphic may be inputted or acquired. In some embodiments, while the pair of images may be similar to one another, they may not be identical to one another. This may mean that the pair of images may be taken from a different angle or at a different point in time. The pair of images may be part of a collection of images acquired by the user. As shown in FIG. 6, for example, the camera may be an apparatus that includes at least one process and/or at least one memory.

In step 120, at least one of an optical flow or a depth map may be calculated based on the acquired pair of images. Optical flow may be the apparent motion of pixels between a pair of images. The depth map, in some embodiments, may be hand drawn by a user or may be generated by depth sensors. As shown in step 130, an energy map may be computed. The energy map may be computed or calculated based on one or more kinetic parameters. In some embodiments, the one or more kinetic parameters may be depth, saliency, and/or centrality, as shown in FIG. 1. Saliency, for example, may be a part of an image on which an observer is likely to fixate. For example, in an image of an eagle the saliency may indicate that the head of the eagle is the part of the image on which an observer fixates. The head of the eagle, as part of the KDI, may exhibit a lower relative velocity than other parts or areas of the KDI.

As discussed above, depth perceived by kinetic motion may depend on relative velocity. Velocity, for example, may be computed by taking at least one of camera parameters, rendering motion, and/or viewing setup into consideration. As shown in step 140, a depth mesh may be generated by remapping the depth map based on the optical flow. As shown in step 140, the depth mesh may be generated using at least one of depth compression, compressed depth, perceptual mapping, and/or mesh enhancement. In certain embodiments, mapping velocity of the KDI to the perceived depth, and accounting for image saliency, may allow for the remapping of the depth map to achieve a depth mesh. Depth compression may also be used, in some embodiments, to generate the depth mesh. Remapping may help to reduce the total motion of the KDI while enhancing depth perception. As shown in step 150, the KDI may be visualized using any desirable rendering camera motions, such as angular motion of a conical pendulum. In step 160, the KDI may be generated based on the depth mesh and the energy map. The generated KDI may be displayed on a rendering camera, or any other user device having a screen.

In certain embodiments, a pivot point may be calculated. The pivot point is the look-at point of the rendering camera as the KDI moves about the rotation axis. The pivot point may be based on the one or more kinetic parameters. In particular, the pivot point may be based on the saliency or the inverted saliency of the pair of images. In some embodiments, the pivot point may be used to generate the KDI. For example, the generated KDI may be rotated around an axis that passes through the pivot point.

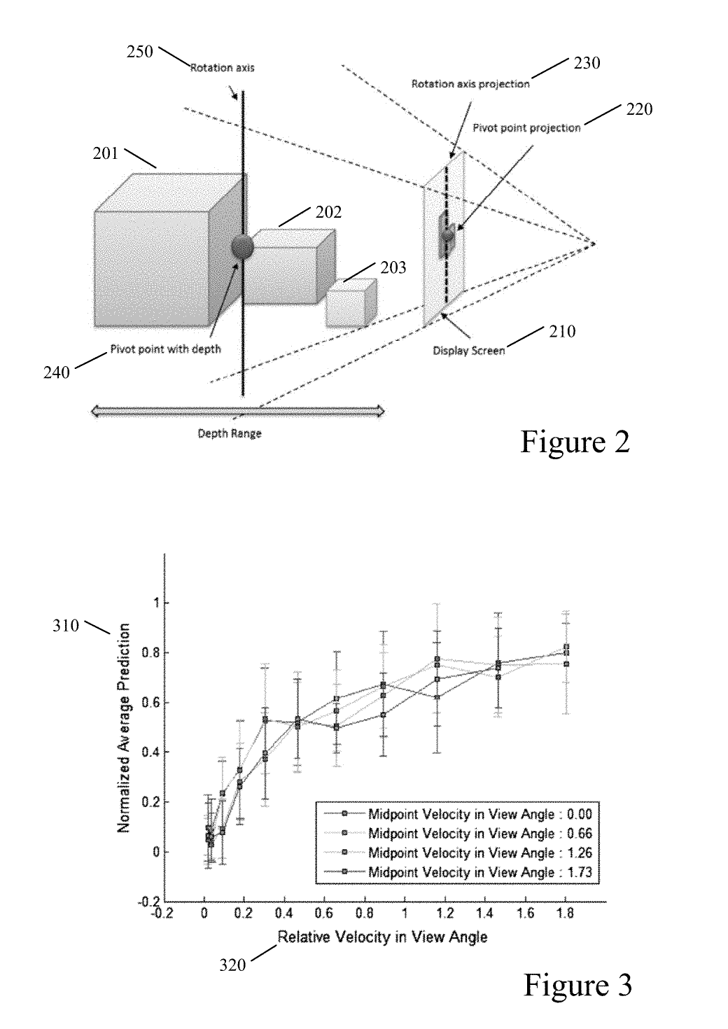

FIG. 2 illustrates an example of a diagram according to certain embodiments. In particular, FIG. 2 illustrates a pivot point projection of objects 201, 202, and 203. As shown in FIG. 2, display screen 210, upon which a KDI may be shown, may include a pivot point projection 220 and a rotation axis projection 230 that passes though pivot point projection 220. In one example, display screen 210 may be included as part of the rendering camera. FIG. 2 also shows a pivot point with depth 240 located between objects 201, 202, and 203. Rotation axis 250 passes through pivot point 240. In certain embodiments, the generate KDI may exhibit minimal optical flow near the region around the pivot point. In other word, the pivot point may be more still or may have a lower velocity than other parts of the KDI surrounding the pivot point.

In addition to calculating pivot point projection 220 and rotation axis projection 230, a magnitude of the angular rotation and/or a frequency may be calculated. For example, an angular rotation between 0.5° and 2.0° per second about the pivot point may be used, while the frequency of rotation may be 2 cycles per second. The angular rotation may be consistent with human vision, where an average intraocular distance is 6.25 centimeters, which gives about 4° of separation at a fixation point 1 meter away. The positioning of the pivot point, frequency of rotation, magnitude of angular rotation, and/or the scene depth range may directly affect the velocity of the stimulus moving on the screen. The scene may be the actual space that the image attempts to capture. In FIG. 2, therefore, the scene includes objects 201, 202, and 203. In some embodiments, depth perceived by kinetic motion may depend on the relative motion of the KDI. Although some increase in relative motion enhances the perception of depth, excess motion may cause motion sickness and reduces the ability to smoothly track objects. To maximize KDE, and to reduce the potential effects of excess motion, certain embodiments may keep motion below 5.0° per second.

To generate the KDI, one or more parameters, other than the kinetic parameters, may be used to generate the KDI. For example, one such parameter may be relative distance. Relative distance between two vertices v and w may be defined by the following equation: R_{d}(v, w)=∥v_{d}−w_{d}∥₂. R_{d} represents a relative distance, while v and w represent vertices in a given image or a pair of images. Another parameter used to determine the KDI may be velocity. Velocity, for example, may be computed or calculated by accounting for at least one of camera parameters, rendering motion, and/or viewing setup. Specifically, the positions of a vertex v in a first image at times t₀ and t₁ may be computed. The position of vertex v at time t₀ may be referred to as \acute{v}ₜ₀, while the position of vertex v at time t₁ may be referred to as \acute{v}ₜ₁. In certain embodiments, camera motion parameters may be used to generate KDE, and to project the KDI on the screen of an apparatus, such as a user device or a computer. The velocity of v in the screen space may then be computed by the following equation:

$${{V}^{′}}_{v} = \frac{{{v}^{′}}_{t 1} - {{v}^{′}}_{t o}}{{t}_{1} - {t}_{0}} .$$

Velocity \acute{V}ᵥ may then be converted into angular velocity, expressed using a view angle by the following equation:

$${V}_{v} = {{V}^{′}}_{v} ( \frac{2 * {tan}^{- 1} ( pixelSize * .5 )}{viewingDistance} ) .$$

The pixel size may be the pixel size of the captured image, while the viewing distance may be the viewing distance of the acquiring camera from the objects in the scene. The relative velocity between two vertices v and w is defined by Rᵥ(v, w)=Vᵥ−V_{w}.

Another parameter, for example, may be a disocclusion threshold. When viewing a depth mesh with a moving camera, regions that were occluded from the input camera used to create the depth mesh may become visible. As a depth mesh, such as a triangulated depth mesh, is drawn, deoccluded regions may be filled by the stretched triangles that space the depth discontinuity from the edge of the foreground object to the background. The stretched triangles may also be referred to as rubber sheets. In order to minimize disocclusion, the rendering camera placement and movement may be constrained. In other words, optimizing camera motion and depth map may help to reduce disocclusion. Even after performing optimization, some disocclusion artifacts may remain due to the structure of the scene. Disocclusion artifacts, for example, may be hidden parts of a scene that come into view due to camera motion. To quantify an amount of perceptible disocclusion when KDI is generation, a disocclusion estimate may be calculated between two vertices v and w defined by the following equation: O_{occ}(v, w)=∥\acute{v}ₜ−\acute{w}ₜ∥_{∞}*C_{lab}(v_{col},w_{col}). The above equation represents the maximum screen space difference over the entire KDE animation being multiplied by the function C_{lab}, which computes color difference in a CIE LAB color space. O_{occ} represents the disocclusion estimate. To determine disocclusion of the entire mesh O_{MeshOcc}, the k largest O_{occ} may be used to compute the average disocclusion in accordance with the following equation:

$${O}_{MeshOcc} = \frac{1}{k} {\sum }_{k} {O}_{occ} .$$

In certain embodiments, the relationship between depth perception, spatial perspective, and the positioning of the pivot point may have an effect of the generate KDE. In generating the KDE, the background and foreground of an object placed at the pivot point may move in opposite directions, while for an object distant from the pivot point the background and foreground move in the same direction. The average velocities of the objects placed at the pivot point may be much lower than for other objects that are distant from the pivot point, and the relative velocity between the foreground and the background of an object decreases considerably when receding from both the view point and the pivot point due to the perspective effect. In some embodiments, the velocity of the pivot point may be close to zero or the pivot point may not undergo any motion.

FIG. 3 illustrates an example of a diagram according to certain embodiments. In particular, FIG. 3 illustrates the high variation in perceived depth by different subjects, and the computed or predicted average of the normalized depth for all subjects for each distance from the pivot point. As shown in FIG. 3, when the objects are placed at various distances from the pivot point, the perceived velocity of the object changes. Each of the separate curves shown in FIG. 3 are representative of a normalized average prediction 310 versus a relative velocity 320 at different view angles of 0°, 0.66°, 1.26°, and 1.73°, respectively. As the relative velocities increase from 0.2 to 1.25 visual angles per second, perceived depth also increases. For higher relative velocities, however, the perceived depth remained constant. In certain embodiments, therefore, a maximum velocity of 1.25 visual angles per second may be desirable. In some other embodiments, a lower or a higher maximum velocity may be used.

As shown in step 130 in FIG. 1, an energy map may be computed. Given that the pivot point may experience minimal optical flow, it may be preferable to locate the pivot point at a salient region or location of the image. In some embodiments, therefore, the pivot point and the salient region may be one of the same in the pair of images. For example, if an image has a text or a face, the text or the face may serve as both the pivot point and the salient region. Reading and/or identifying the text or face at the pivot point may be easier when the region does not experience high optical flow due to the rendering camera movement. In certain embodiments, the pivot point may be located in the middle of the images, in order to minimize the optical flow at the scene boundaries. In other embodiments, however, the pivot point may be located at any other location in the image. When the pivot point is chosen at a scene boundary, the opposite end of the image may exhibit excessive motion that can create visual discomfort, and may also give rise to significant disocclusion artifacts.

The placement of the pivot point may be determined by computing an energy map. The energy map may then be used determine the KDE. In certain embodiments, the energy map may be determined using the following equation, which accounts for one or more kinetic parameters: E(x, y)=E_{d}(x, y)+Eₛ(x, y)+Eᵣ(x, y). (x, y). E(x, y) may refer to the position of the pivot point in the original image, such as pivot point projection 220 in FIG. 2, while E_{d}(x, y), Eₛ(x, y), and Eᵣ(x, y) may be the radial, depth, and saliency energy functions, respectively.

Depth energy, for example, may be a preference for positioning the pivot point on regions that are close to the middle of the depth map. This may help to minimize the visibility of the occluded regions during the rendering camera movement, and/or may also lower the amount of motion when the final KDI is generated. The depth map of a given image may be obtained by calculating the optical flow of the map using any available algorithm. Once the depth map is calculated, the depth energy map may be calculated using the following equation: E_{d}(x, y)=∥P_{d}(x, y)−Dₘ∥₂·P_{d}(x, y) may refer to the depth value of the pixel at (x, y), while Dₘ refers to the median depth of the scene.

The position of the pivot point may be on a salient region of the image. The salient regions, in certain embodiments, may be different in color, orientation, and intensity from their neighbors, and may be found using a saliency algorithm. The saliency map may represent high-saliency regions with high values. When calculating the saliency energy of the pivot point, the saliency values may be inverted so that the most salient regions may be represented with the lowest values. The saliency energy may be calculated as follows: Eₛ(x, y)=[1−Pₛ(x,y)], where Pₛ may refer to the saliency value of the pixel.

To express preference for a centralized pivot point, a radial energy function, also referred to as a centrality energy function, may be used as one of the energy components. The closer the pivot point may be to the center, the less radial energy may be associated with the pivot point. The radial energy may be calculated using the following equation: Eᵣ(x, y)=Pᵣ(x, y), where Pᵣ may refer to the radial value of the pixel defined by a Euclidean distance between the point and the image center. Radial component Pᵣ(x, y) may depend upon the dimensions of the image, while the saliency component Pₛ(x, y) and the depth component P_{d}(x, y) may depend upon the scene, meaning the content of the image itself.

In certain embodiments, different weights may be assigned to at least one of the radial, saliency, and depth components when calculating the energy function. Assigning a higher saliency weight may increase the importance of the saliency region, for example, whereas a higher depth weight and radial weight may give greater priority to the image center and may lower the total optical flow between the frames. Using the one or more kinetic parameters, such as saliency, depth, and radial component, may be used to compute the energy of all the pixels and to find the position that has the lowest energy. The pivot point may therefore be defined by the following coordinate: [x, y, P_{d}(x, y)].

As illustrated in step 140 in FIG. 1, a depth mesh may be achieved or generated. The depth mesh may be generated by approximating the scene depth, followed by an optimized compression for KDE. Remapping of the depth map may also be performed. The remapping may take depth perception into account when generating the depth mesh. The depth mesh may then be enhanced so that the motion may be constrained to a desired range and/or disocclusion artifacts are minimized.

The number of input images or photographs may be smaller than the desired number of views. The parameters used by the rendering cameras may also be different from the input cameras. In certain embodiments, therefore, additional intermediate frames may be generated. The intermediate frames may be generated using at least one of basic interpolation between input images, flow-field interpolation, image-based rendering, and/or structure approximation in order to create the depth mesh. In some embodiments, depth image based rendering may be used to generate high quality intermediate frames for achieving the KDE. The depth image based rendering may be computationally efficient and may allow for sufficient flexibility in the choice of the rendering camera parameters.

In certain embodiments, for every pair of images acquired a depth map may be calculated, as shown in FIG. 1. The depth map, for example, may be computed or approximated based on the optical flow between the input image pair by using the inverse relation defined as

$$d = f \frac{t}{0} ,$$

where d is the depth, f is the focal length, t is the distance between the camera positions, and o is the optical flow magnitude of the pixel. Since camera parameters f and t, may not be known for example, a depth projection approximation may be used. Optical flow between images may be represented using a vector field. Objects at the zero plane may have zero optical flow, while objects that are in front and behind the zero plane may have optical flow vectors facing in the opposite direction. Taking either the maximum or minimum optical flow, and adding it to the entire vector field may shift the zero plane to either the closest or the furthest depth. The optical flow map may then be converted to the depth map.

The depth range of a raw depth map may be very high, and may include a lot of artifacts. Directly using a raw depth map may therefore cause excessive motion that is visually disconcerting. In KDI, depth compression may be helped by providing consistency of the scene depth as the depth mesh is viewed from different angles. In certain embodiments, depth compression based on the image saliency may be used, and one or more chosen edges may be used as part of the compression to enforce feature preservation. The compression depth, therefore, may account for both saliency and/or scene edges.

As part of the compression, for example, the depth range may divide the mesh evenly into k intervals, {r₀, r₁, . . . rₖ₋₁}. In certain embodiments, a greater compression of the depth intervals that are largely empty or have low-salience vertices may be utilized. To achieve this, a histogram may be built over the depth intervals rₓ and vertex counts that are weighted by their respective saliencies may be used. Each vertex's saliency may be range from 0 to 1. A compressed value sₓ for the rₓ may then be calculated using the following equation:

$${s}_{k} = min ( \frac{{h}_{x}}{g * max ( {h}_{0} , {h}_{1} , … {h}_{k} - 1 )} ) .$$

sₓ may be the size of interval x after using saliency compression, and g may be a constant which gives extra rigidity to salient depth intervals. For example, g may equal 0.4, and may provide a proper balance between compression and rigidity of depth intervals. Non-linear mapping may then be used to compress the intervals that are less salient.

In certain embodiments, using saliency to compress the depth map may cause features, such as lines and curves, to change. This may be caused by depth intervals being compressed non-linearly. To preserve some features, and prevent the unwarranted changing of lines and curves, some constraints may be placed. For example, edge information may be chosen to enforce loose feature preservation. Edges may be calculated using any available edge detection method. Edges that are short in length may be filtered to remove noise. Additional filtering may be performed to remove edges that lie at the border region of objects at various depths. For example, an edge having a very high gradient on its depth value may be removed. After filtering is complete, the remaining edges will have more reliable depth values. This is because the depth map includes errors or artifacts, and depth approximations closer to the depth boundaries are less reliable. The depth interval associated with each of the filtered edges

As discussed above, the filtered edges may be used for feature preservation. In some embodiments, the depth interval associated with each of the filtered edges may be determined and uniformly distributed. The following equation may be used to represent the new size of the depth interval after using saliency compression with feature preservation:

$${S}_{x}^{*} = \frac{{\sum }_{n = i}^{j} {s}_{n}}{j - 1} \cdot {S}_{x}^{*}$$

may be the new size of the depth interval x after using saliency compression with feature preservation. i and j may be the depth intervals associated with the two endpoints of the filtered edge and x ∈ [i, j]. The calculated compressed depth may then be used to create a compressed depth mesh M_{Comp}.

As shown in step 140 of FIG. 1, the remapped depth mesh may be generated by taking depth perception into account. In certain embodiments, relative depth computed from the compressed depth mesh M_{Comp} may be used as an input to generate a relative velocity map used to perceive the desired depth. The relative velocity map may be generated for each step of the vertex v in M_{Comp}. For each v, Vₙ may be a set of its four connected neighbors such that Vₙ ⊆M_{Comp}, with ⊆ being a subset. Four vertex-neighbor pairs (v, w) may be created, where w is the set of Vₙ. For each pair of (v, w), the relative depth R_{d}(v, w) between them may be computed. The relative depth may be scaled so that it may be within the maximum depth range allowed in a given scene. The maximum depth range, in some embodiments, may be initialized to the depth range that results in a relative velocity that is equal to the maximum desirable relative velocity, as discussed above. The scaled depth may then be used as an input for the map to get the relative velocity Vₚ(v, w) between a vertex pair. Vₚ(v, w) may be a perceptual relative velocity. Vₚ(v, w) between a vertex pair may be helpful to perceive the relative depth R_{d}(v, w) between them. In other words, to perceive a depth that is equal to R_{d}(v, w) between a vertex pair, the relative velocity between the vertex pair may be equal to Vₚ(v, w).

The perceptual relative velocities between vertices may also be used to computer their separation, which may be referred to as perceptual separation Sₚ(v, w). For example, one of the vertices in (v, w) may be moved along the line of the view point in order to find the separation Sₚ(v, w) that results in the desired relative velocity Vₚ(v, w). In certain embodiments, the relative velocity between a pair of vertices may be computed by projecting each vertex on the display screen using a standard projection matrix, calculating instantaneous velocity for each vertex, and finding the difference between the velocities. The calculation described in the above embodiments may be accelerated by used of a binary search algorithm.

Because the calculation of the relative velocity and separation may use local data to determine the distance between neighbors (v, w), an additional step may be used to ensure that the depth mesh may be globally consistent. In doing so, the depth of a given scene may be divided into 255 discrete bins. For each (v, w), associated discrete depths dᵥ and d_{w} may be determined based on their depth in M_{Comp}. A link may then be added between dᵥ and d_{w} that specifies the Sₚ(v, w). In some embodiments, the calculation of the dᵥ and d_{w} may be viewed as a spring mesh where the links added will act like a spring, and the discrete depths are the locations where the springs are attached. Since the Sₚ(v, w) may be locally consistent, some links may try to contact the distance between the discrete depths, while other links may try to expand them. In certain embodiments, for all (v, w), a d(v, w)=|dᵥ−d_{w}| may be determined to help minimize Σ∥d(v, w)−Sₚ(v, w)∥₂ to perceptually remap the depth mesh Mₚ to make it more globally consistent.

The optimized depth compression and perceptual remapping discussed above may help to carry out local depth enhancement using local per-pixel neighborhoods. Using local per-pixel neighborhoods, however, may cause the range of the motion for the entire image to be too low or too high. In some embodiments, global optimization may be performed to create a more pleasant viewing experience. Depending on the rendering parameters and the depth range of the scene, a depth mesh may be compacted or expanded to allow enhanced depth perception. For example, depth may be adjusted to reduce disocclusion artifacts. When using KDE, depth perception may be limited depending on the relative velocity. The relative velocity of the object may depend upon the relative distance between two vertices, the placement of the pivot point, and/or the camera movement. There may be a tradeoff between the amount of motion in the scene due to relative velocity and the perception of depth. The calculation of relative velocity described above may help to maximize the desired velocity while also accounting for this tradeoff.

Using at least one of the maximum desirable relative velocity, perceptual depth mesh, and/or placement of the pivot point, the maximum depth range Dₘₐₓ allowed in the scene may be determined. In other words, perceptual depth mesh and placement of the pivot may be used to determine a depth range Dₘₐₓ which results in a relative velocity that may be equivalent to or similar to the maximum desirable relative velocity between the front and back extremes of the mesh. In certain embodiments, therefore, the depth range that results in the desirable relative velocity may be determined. The minimum depth range allowed in the scene may then be determined by the following equation: Dₘᵢₙ=0.5*Dₘₐₓ.

Once the allowable depth range is found, the depth range that minimizes disocclusion artifacts may be determined. In between vertices, disocclusion may be estimated by computing or calculating relative separation in pixel units between neighboring vertices of the depth mesh when the camera movement used in KDI is performed. When colors between the vertices are the same, disocclusion may not be visible. As such, vertices having the same colors may be ignored. To approximate disocclusion of an entire scene O_{MeshOcc}, the mean of the k-highest disocclusion estimates between vertices whose color is perceptually different may be taken. When the depth range is small, disocclusion artifacts and perception of depth may be reduced. The depth range, for example, may therefore be determined by the following equation:

$${D}_{Final} = \{ \begin{matrix}{D}_{Mi n} , if ( {D}_{opt} \leq {D}_{M i n} ) \\ {D}_{M a x} , if ( {D}_{Opt} \geq {D}_{M ax} ) \\ {D}_{Opt} , otherwise\end{matrix} .$$

D_{Opt} may be the depth range that has k-highest disocclusion estimates that are less than a user-specific threshold. The user-specific threshold may have a value of 2. When the difference between D_{Final} and the depth range of Mₚ is small, the scale of the depth range may be scaled to match D_{Final}. However, if the depth range is large, the maximum depth range allowed in the scene may be modified, and perceptual re-mapping may be occur. D_{Final} may be a form of constraint on the movement and/or depth of the camera used to minimize disocclusion.

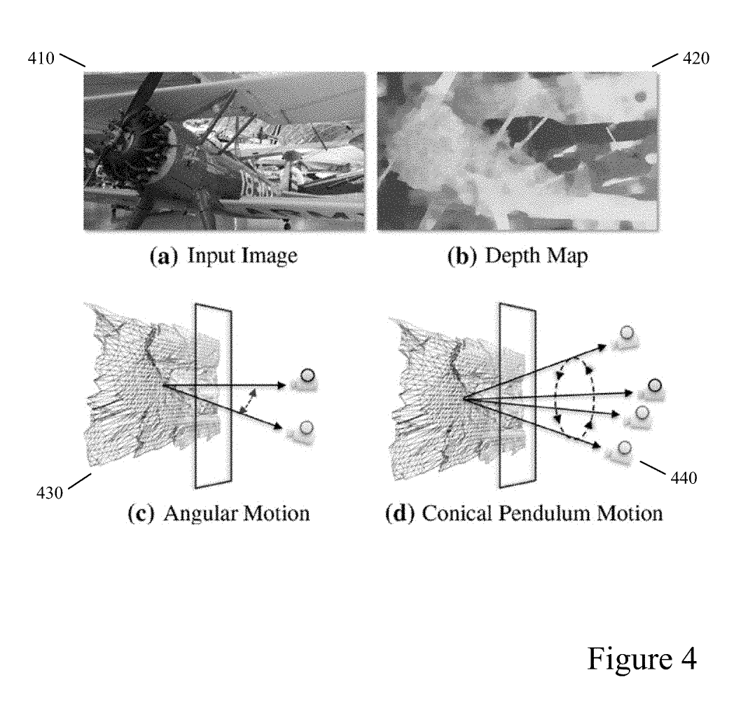

FIG. 4 illustrates an example of diagrams according to certain embodiments. In particular, FIG. 4 an input image 410 and an optimized depth map 420. In certain embodiments, a motion to maximize the KDE effect in the KDI may be computed. The motion for example, may be a circular, angular, or conical pendulum motion. Angular motion, for example, may include rotating the camera on a plane perpendicular to the rotation axis while looking at the pivot point. An example of angular motion is illustrated by angular motion 430 shown in FIG. 4. In other words, rather than simply flipping between two images and only relying of the sequence of images that were captured by camera, intermediate views may be generated by rotating the rendering camera positions along an arc subtending a fixed angle at the salient picot position. In yet another example, conical pendulum motion 440, as shown in FIG. 4, may be used. Conical pendulum motion may include rotating the camera along a circle on a plane parallel to the view-plane, as the vector from the camera to the look-at pivot point traces out a cone.

As shown in FIG. 1, the depth mesh, along with the camera motion, may be used to render the scene. The depth mesh may be kept static while the rendering camera moves to generate the KDE. In certain embodiments, virtual objects or different layers may be added into the scene at a user-specified depth location. Camera parameters may be used to render additional geometry at the desired locations while also rendering the depth mesh. The generated kinetic depth motion may be consistent and/or account for both the depth mesh as well as the additionally-added geometry. Some other embodiments may also be used to make lighting and/or shading seamless in the KDI, and to create increase consistency between any added virtual objects and the scene. While FIG. 1 provides for an automatic computation or generation of the pivot point and the rotation axis, a user may further customize the output of the kinetic-depth movement. For example, the user may move the pivot point after the pivot point before or after the pivot point has been automatically determined.

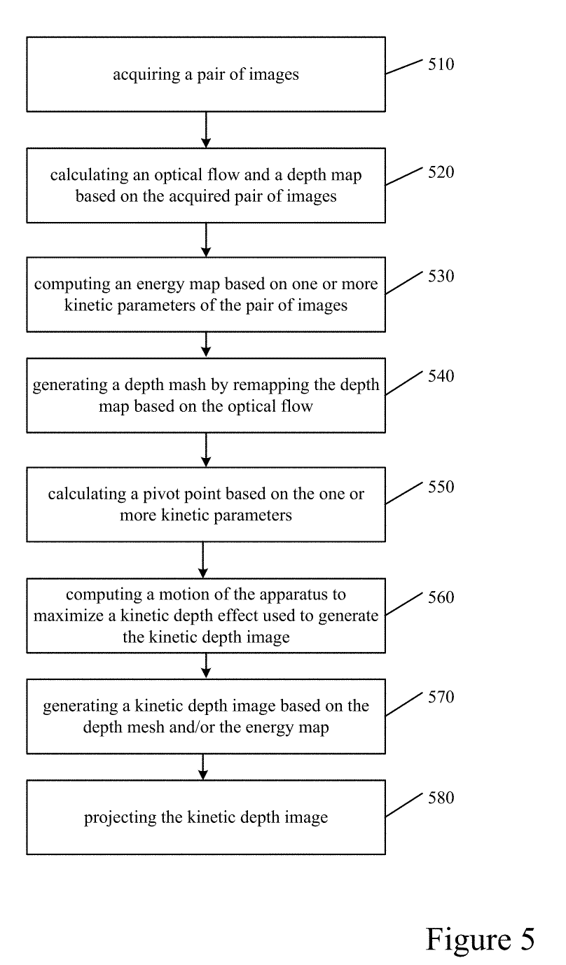

FIG. 5 illustrates an example of flow diagram according to certain embodiments. In particular, FIG. 5 illustrates an example of a method performed by an apparatus, such as a camera. In some other embodiments, the method may be performed by a combination of an input camera and/or a rendering camera. In step 510, the apparatus may acquire a pair of images. The pair of images are included as part of a collection of images. The pair of images may include at least one of a still image, a video image, a vector graphic, a three dimensional gestural drawing, or a light field. In step 520, the optical flow and a depth map may be calculated based on the acquired pair of images. In step 530, an energy map may be computed based on one or more kinetic parameters of the pair of images. The one or more kinetic parameters, for example, may include at least one of depth, centrality, or saliency. The depth, centrality, and saliency may be calculated based on at least one of depth energy, radial energy, and saliency energy, respectively.

In step 540, the depth mesh may be generated by remapping the depth map based on the optical flow. The remapping of the depth map to generate the depth mesh may enhance depth perception of the kinetic depth image. The depth perception depends on a relative velocity of the kinetic depth image. A maximum of the relative velocity may be optimized, for example, at 1.25 visual angle per second. The depth perception of the generated kinetic depth image may be a non-linearly varying depth perception. In certain embodiments, the depth mesh may be produced using an optimized depth compression based on at least one of saliency of the pair of images or chosen edges of the pair of images. In step 550, the pivot point may be calculated based on the one or more kinetic parameters. The generated kinetic depth image may be rotated around an axis that passes through the pivot point. The pivot point may have a lower velocity than other parts of the kinetic depth image.

In step 560, a motion of the apparatus may be computed to maximize a kinetic depth effect used to generate the kinetic depth image. The generated kinetic depth image may use the computed motion. The motion, for example, may be angular or conical. In step 570, the kinetic depth image may be generated based on the energy map. The kinetic depth map may also be generated based on the depth mesh. In certain embodiments, the kinetic depth image may be generated based on at least one image of the pair of images and a depth map. The depth map may be hand drawn or generated by depth sensors. In step 580, the kinetic depth image may be projected on a screen of the apparatus or another apparatus.

FIG. 6 illustrates a system according to certain embodiments. It should be understood that each table, signal, or block in FIGS. 1-5 may be implemented by various means or their combinations, such as hardware, software, firmware, one or more processors and/or circuitry. In one embodiment, a system may include one or more apparatuses or devices 610. The apparatus for example may be a rendering camera, an input camera, or a capture camera. In other embodiments, the apparatus may include a user device capable of capturing an image, video, or a vector graphic. In certain embodiments, the apparatus may be an input camera, while another apparatus may be a rendering camera.

The apparatus may include at least one processor or control unit or module, indicated as 611. At least one memory, indicated as 612, may be provided in the apparatus. The memory may include computer program instructions or computer code contained therein. One or more transceivers 613 may be provided, and each apparatus or device may also include an antenna, illustrated as 614. Although only one antenna each is shown, many antennas and multiple antenna elements may be provided to the apparatus. Other configurations of the apparatus may be provided. For example, the apparatus may be configured for wired communication, in addition to wireless communication, and in such a case antennas 614 may illustrate any form of communication hardware, without being limited to merely an antenna.

Transceiver 613 may, independently, be a transmitter, a receiver, or both a transmitter and a receiver, or a unit or device that may be configured both for transmission and reception. One or more functionalities may also be implemented as virtual application(s) in software that can run on a server.

In some embodiments, the apparatus may include means for carrying out embodiments described above in relation to FIGS. 1-5. In certain embodiments, at least one memory including computer program code can be configured to, with the at least one processor, cause the apparatus at least to perform any of the processes described herein.

Processor 611 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memory 612 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof. The memory may be fixed or removable.

The memory and the computer program instructions may be configured, with the processor for the particular device, to cause a hardware apparatus 610 to perform any of the processes described above (see, for example, FIGS. 1-5). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

In certain embodiments, an apparatus may include circuitry configured to perform any of the processes or functions illustrated in FIGS. 1-5. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

Furthermore, although FIG. 6 illustrates a single apparatus 610, certain embodiments may be applicable to other configurations, and configurations involving additional elements, as illustrated and discussed herein. For example, multiple apparatuses or devices may be present.

The above embodiments are directed to computer-related technology, and provide for significant improvements to the functioning of a network and/or to the functioning of the network entities within the network, or the user equipment communicating with the network. For example, certain embodiments help to provide for automatic generation of a high quality KDI. The energy map and the depth mesh may be used to generate the KDI, without a user having to exhaust manual or network resources to produce the KDI. The KDI may then be illustrated on a screen of the apparatus, and the motion of the KDI may be rotational or conical. The above embodiments may allow for the decoupling of the rendering and acquisition cameras, and may allow for greater freedom in using the standard angular camera with substantially fewer visual artifacts to generate the KDE.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

Partial Glossary

| | |
|---|---|
| KDE | Kinetic Depth Effect |
| KDI | Kinetic Depth Image |
| SKE | Stereo Kinetic Effect |

We claim:

1. An apparatus comprising:
at least one memory comprising computer program code;
at least one processor;
wherein the at least one memory and the computer program code are configured, with the at least one processor, to cause the apparatus at least to:
acquire a pair of images;
compute an energy map based on one or more kinetic parameters of the pair of images; and
generate a kinetic depth image based on the energy map.

2. The apparatus according to claim 1, wherein the at least one memory and the computer program code are configured, with the at least one processor, to cause the apparatus at least to:
calculate an optical flow and a depth map based on the acquired pair of images; and
generate a depth mesh by remapping the depth map based on the optical flow, wherein the depth mesh is used to generate the kinetic depth image.

3. The apparatus according to claim 1, wherein the kinetic depth image is generated based on at least one image of the pair of images and a depth map, and wherein the depth map is hand drawn or generated by depth sensors.

4. The apparatus according to claim 1, wherein the at least one memory and the computer program code are configured, with the at least one processor, to cause the apparatus at least to:
compute a motion of the apparatus to maximize a kinetic depth effect used to generate the kinetic depth image, wherein the generated kinetic depth image uses the computed motion.

5. The apparatus according to claim 4, wherein the motion is angular or conical.

6. The apparatus according to claim 1, wherein the one or more kinetic parameters comprises at least one of depth, centrality, or saliency.

7. The apparatus according to claim 6, wherein the depth, centrality, and saliency are calculated based on at least one of depth energy, radial energy, and saliency energy, respectively.

8. The apparatus according to claim 2, wherein the remapping of the depth map to achieve the depth mesh enhances depth perception of the kinetic depth image, wherein the depth perception depends on a relative velocity of the kinetic depth image.

9. The apparatus according to claim 8, wherein the depth perception of the generated kinetic depth image is a non-linearly varying depth perception.

10. The apparatus according to claim 8, wherein a maximum of the relative velocity is optimized at 1.25 visual angle per second.

11. The apparatus according to claim 1, wherein the at least one memory and the computer program code are configured, with the at least one processor, to cause the apparatus at least to:
calculate a pivot point based on the one or more kinetic parameters, wherein the generated kinetic depth image is rotated around an axis that passes through the pivot point.

12. The apparatus according to claim 11, wherein the pivot point may have a lower velocity than other parts of the kinetic depth image.

13. The apparatus according to claim 1, wherein the pair of images are included as part of a collection of images.

14. The apparatus according to claim 1, wherein the pair of images includes at least one of a still image, a video image, a vector graphic, a three dimensional gestural drawing, or a light field.

15. The apparatus according to claim 2, wherein the depth mesh is produced using an optimized depth compression based on at least one of saliency of the pair of images or chosen edges of the pair of images.

16. The apparatus according to claim 1, wherein the at least one memory and the computer program code are configured, with the at least one processor, to cause the apparatus at least to:
project the kinetic depth image on a screen of the apparatus or another apparatus.

17. A method comprising:
acquiring at an apparatus a pair of images;
computing an energy map based on one or more kinetic parameters of the pair of images; and
generating a kinetic depth image based on the depth mesh and the energy map.

18. The method according to claim 17, further comprising:
calculating an optical flow and a depth map based on the acquired pair of images; and
generating a depth mesh by remapping the depth map based on the optical flow, wherein the depth mesh is used to generate the kinetic depth image.

19. The method according to claim 17, wherein the kinetic depth image is generated based on at least one image of the pair of images and a depth map, and wherein the depth map is hand drawn or generated by depth sensors.

20. The method according to claim 17, further comprising:
computing a motion to maximize a kinetic depth effect used to generate the kinetic depth image, wherein the generated kinetic depth image uses the computed motion.

21. The method according to claim 20, wherein the motion is angular or conical.

22. The method according to claim 17, wherein the one or more kinetic parameters comprises at least one of depth, centrality, or saliency.

23. The method according to claim 22, wherein the depth, centrality, and saliency are calculated based on at least one of depth energy, radial energy, and saliency energy, respectively.

24. The method according to claim 18, wherein the remapping of the depth map to achieve the depth mesh enhances depth perception of the kinetic depth image, wherein the depth perception depends on a relative velocity of the kinetic depth image.

25. The method according to claim 24, wherein the depth perception of the generated kinetic depth image is a non-linearly varying depth perception.

26. The method according to claim 24, wherein a maximum of the relative velocity is optimized at 1.25 visual angle per second.

27. The method according to claim 17, further comprising:
calculating a pivot point based on the one or more kinetic parameters, wherein the generated kinetic depth image is rotated around an axis that passes through the pivot point.

28. The method according to claim 27, wherein the pivot point may have a lower velocity than other parts of the kinetic depth image.

29. The method according to claim 17, wherein the pair of images are included as part of a collection of images.

30. The method according to claim 17, wherein the pair of images includes at least one of a still image, a video image, a vector graphic, a three dimensional gestural drawing, or a light field.

31. The method according to claim 17, wherein the depth mesh is produced using an optimized depth compression based on at least one of saliency of the pair of images or chosen edges of the pair of images.

32. The method according to claim 17, further comprising:
projecting the kinetic depth image on a screen of the apparatus or another apparatus.
